(19) United States
(12) Patent Application Publication
(10) Pub. No.: US 2002/0095801 A1
(43) Pub. Date: Jul. 25, 2002

(54) Can opener

(76) Inventor: Akio Hayashi, Shizuoka (JP)

Correspondence Address: STETINA BRUNDA GARRED & BRUCKER, 75 ENTERPRISE, SUITE 250, ALISO VIEJO, CA, 92656, US

(21) Appl. No.: 10/020,125

(22) Filed: Dec. 14, 2001

(30) Foreign Application Priority Data
Jan. 22, 2001 (JP) 2001-13500

(51) Int. Cl. B67B 7/46

(52) U.S. Cl. 30/400

(57) ABSTRACT

A can opener with simple construction for easily and safely opening pull-top cans and the like without particular attention to the handling and storing thereof. The can opener according to the present invention comprises: a cylindrical main body; an engagement projection disposed on a circumferential surface of the main body, the engagement projection having a claw extending in a direction parallel to the axis of the main body; and a handle for rotating the main body, the handle being continuous with the main body.

### CROSS-REFERENCE TO RELATED APPLICATIONS

The present application claims priority to Japanese Patent Application No. 2001-13500 entitled CAN OPENER filed on Jan. 22, 2001.

### BACKGROUND OF THE INVENTION

1. Field of the Invention

The present invention relates to a can opener for easily and safely opening pull-top cans containing food or the like therein.

2. Description of the Related Art

In recent years, pull-top cans packing food or the like have been widely used. The pull-top can can be opened at the top cover thereof by only pulling a pull tab near the periphery of the cover. Although the pull-top can is useful since it can be opened by a single motion, a considerable amount of force is required to raise the pull tab through the use of a tip of a nail at the opening of the can, and there is a fear that a hand or a finger may be cut by the edge of the cover during the cutting or removal operation. Therefore, it cannot be said that the can is always safe and useful for everyone. Especially, elders, ladies and children of little strength spend remarkable effort and must pay close attention to the opening.

In consideration of the above problem, various kinds of can openers have been proposed. For instance, the can opener disclosed in Japanese Patent Application Laid-open No. Heisei 8-295339 is, as illustrated in FIG. 7, provided with a chisel-shaped tip 52 at an end of a main body 51 of a pipe or a shaft, a handle 53 for rotating the main body 51 at the other end thereof, and a mushroom-shaped engagement projection 54 in the middle of the main body 51. When opening a pull-top can, a user inserts the tip 52 under a pull tab on a cover and raises the pull tab. Then the user rotates the handle 53 after engaging the engagement projection 54 with an opening of the pull tab, and the can is opened as the cover is rolled away.

However, in the can opener disclosed in the above patent application, at the opening of the pull-top can, after the tip 52 is inserted under the pull tab of the cover of the can to raise the pull tab, the opener is shifted from one hand to the other to engage the engagement projection 54 with the opening of the pull tab and rotate the handle 53. That is, two different motions are necessary. In addition, the diameter of the main body 51 is so small that it is not easy to smoothly rotate the main body 51 through the handle 53. So, the opener is not necessarily efficient at the opening of the cans. Further, the tip 52 is shaped like a chisel, therefore, especially when it is made of metal, the tip 52 may damage a hand or a body of a person handling the tool. So, it is necessary to pay attention to the handling and storing of the can opener.

### BRIEF SUMMARY OF THE INVENTION

It is therefore the object of the present invention to provide a can opener with simple construction for easily and safely opening pull-top cans and the like without particular attention to the handling and storing thereof. To accomplish the above objective, a can opener according to the present invention comprises: a cylindrical main body; an engagement projection standing on a circumferential surface of the main body, the engagement projection having a claw extending in a direction parallel to an axis of the main body; and a handle for rotating the main body, the handle being continuous to the main body.

With the construction of the can opener, the cover of a pull-top can is to be opened by only rotating the opener such that the cover is rolled together with the main body with the claw of the engagement projection, which stands on the circumferential surface of the main body, catching a pull tab of the pull-top can. Therefore, it is unnecessary to shift the opener from one hand to the other like a conventional can opener, and the pull-top can is easily and safely opened by a single motion. The can opener of the present invention is applicable to stay-on cans also. Further, the can opener of the present invention has no sharp portion like a conventional opener, so that particular attention is not required at opening operations.

Another can opener according to the present invention comprises: a cylindrical main body; an engagement projection standing on a circumferential surface of the main body, the engagement projection having two claws extending in both directions parallel to an axis of the main body; and a handle for rotating the main body, the handle being continuous to the main body.

With this construction, since two claws are mounted to the engagement projection, which stands on the circumferential surface of the cylindrical main body, some pull-top cans that cannot be opened by only rotating a main body of an opener can be opened by adding a reverse rotation with the can opener of the present invention. As a result, this can opener is applicable to most pull-top cans.

In the above can openers according to the present invention, the outer diameter of the main body may be designed from 20 mm to 25 mm, which allows pull-top cans to be opened by relatively small force.

Further, in the can openers according to the present invention, a half-ring-shaped projection can be mounted on a face opposite a face of the circumferential surface of the main body where the engagement projection stands.

With this construction, at the opening of the pull-top can, a joint of the pull tab is to be depressed by the projection, which causes the release of the engagement between the engagement projection and the pull tab to become more difficult, resulting in an easier opening operation. In addition to this, the projection allows the pull-top can to be opened through a portion that is positioned slightly more outside than a portion of the outer circumferential surface of the main body as a fulcrum, so that the pull-top can can be opened with smaller force.

### BRIEF DESCRIPTION OF THE DRAWINGS

The present invention will be more apparent from the ensuing description with reference to the accompanying drawings wherein:

FIGS. 1A to 1C show a can opener according to an embodiment of the present invention, in which FIG. 1A is an overall perspective view of the can opener, FIG. 1B a cross-sectional view taken on line A-A of FIG. 1A, and FIG. 1C a cross-sectional view taken on line B-B of FIG. 1B;

FIGS. 2A to 2D show an engagement projection of the can opener illustrated in FIG. 1, in which FIG. 2A is a front view, FIG. 2B a side view, FIG. 2C a top view, and FIG. 2D a bottom view of the engagement projection;

FIGS. 3A to 3C are drawings for explaining a usage of the can opener illustrated in FIG. 1, in which FIG. 3A shows a condition that a claw catches a pull tab, FIG. 3B a condition that the claw catching the pull tab is rotated, and FIG. 3C a condition that the opening of the can is almost completed by rotating a main body of the opener through a handle in such a manner as to roll the cover together with the main body;

FIGS. 4A to 4D are drawings for explaining another usage of the can opener illustrated in FIG. 1, in which FIG. 4A shows a condition that a claw catches a pull tab, FIG. 4B a condition that another claw engaging an intermediate member of the pull tab is rotated to open a portion of a cover, FIG. 4C a condition that the claw catching the pull tab is rotated, and FIG. 4D a condition that the opening of the can is almost completed by rotating a main body of the opener in such a manner as to roll the cover together with the main body;

FIGS. 5A to 5D show another engagement projection of the can opener illustrated in FIG. 1, in which FIG. 5A is a front view, FIG. 5B a side view, FIG. 5C a top view, and FIG. 5D a bottom view of the engagement projection;

FIGS. 6A to 6C show a can opener according to another embodiment of the present invention, in which FIG. 6A is an overall perspective view of the can opener, FIG. 6B a cross-sectional view taken on line E-E of FIG. 6A, and FIG. 6C a cross-sectional view taken on line F-F of FIG. 6B; and

FIGS. 7A and 7B show a conventional can opener, in which FIG. 7A is a plan view, and FIG. 7B is a front view of the can opener.

### DETAILED DESCRIPTION OF THE INVENTION

The can opener according to the present invention will be described in detail with references to the accompanying drawings.

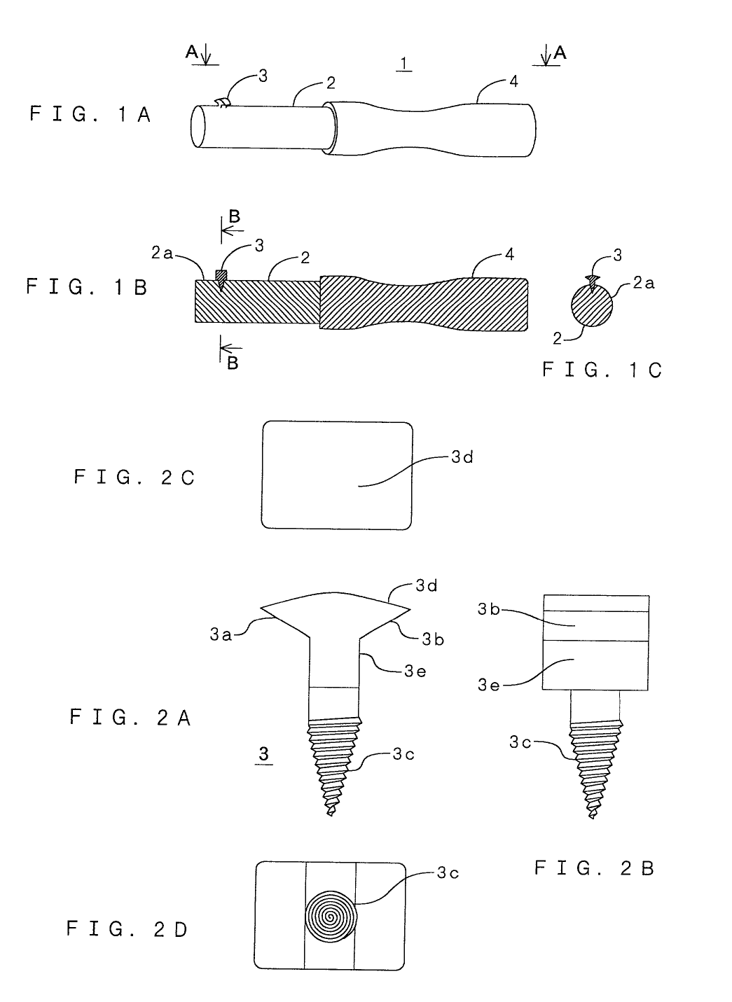

FIG. 1 shows the construction of a can opener according to an embodiment of the present invention. The can opener 1 is provided with a cylindrical main body 2, an engagement projection 3 standing on a circumferential surface 2a of the main body 2, and a handle 4 continuous to the main body 2 to rotate the main body 2.

The main body 2 is cylindrically formed, and the outer diameter thereof is preferably in the range of from about 20 mm to about 25 mm. The main body 2 is not always a solid cylinder but may be a hollow cylinder with an open end.

The engagement projection 3 is, as illustrated in FIG. 2, provided with two claws 3a, 3b at the upper portion thereof and a screwed portion 3c at the lower portion. A top portion 3d of the engagement projection 3 is formed to be rectangular when observed from upside. A trunk portion 3e between the claws 3a, 3b and the screwed portion 3c is formed to be a rectangular parallelepiped. And, as illustrated in FIG. 1, the engagement projection 3 is fixed to the circumferential surface 2a of the main body 2 through the screwed portion 3c in such a manner that the claws 3a, 3b are directed toward both directions parallel to the axis of the main body 2.

The handle 4 is continuous to the main body 2 and formed so as to easily be grasped and rotatable.

All of the main body 2, engagement projection 3 and handle 4 can be made of metal or plastic, or only the engagement projection 3 may be made of metal, and the main body 2 and the handle 4 may be made of wood.

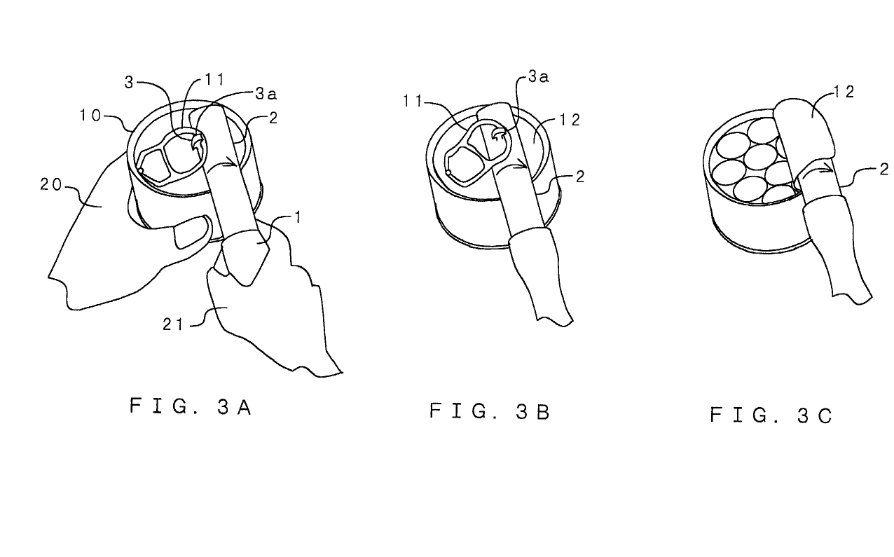

Next, the usage of the can opener 1 with the above construction will be explained with reference to FIG. 3.

At first, as illustrated in FIG. 3A, a can 10 is grasped by the left hand 20 and the can opener 1 is gripped by the right hand 21, and a pull tab 11 of the can 10 is caught by the claw 3a to rotate the main body 2 in a direction shown by the arrow, which allows the overall engagement projection 3 to enter the opening of the pull tab 11.

Then, as illustrated in FIG. 3B, the main body 2 is rotated in a direction shown by the arrow with the claw 3a catching the pull tab 11, which allows the cover 12 to gradually be opened.

Next, as illustrated in FIG. 3C, the main body 2 is rotated further in a direction shown by the arrow in such a manner that the cover 12 is rolled together with the main body 2. Finally, the cover 12 is completely removed.

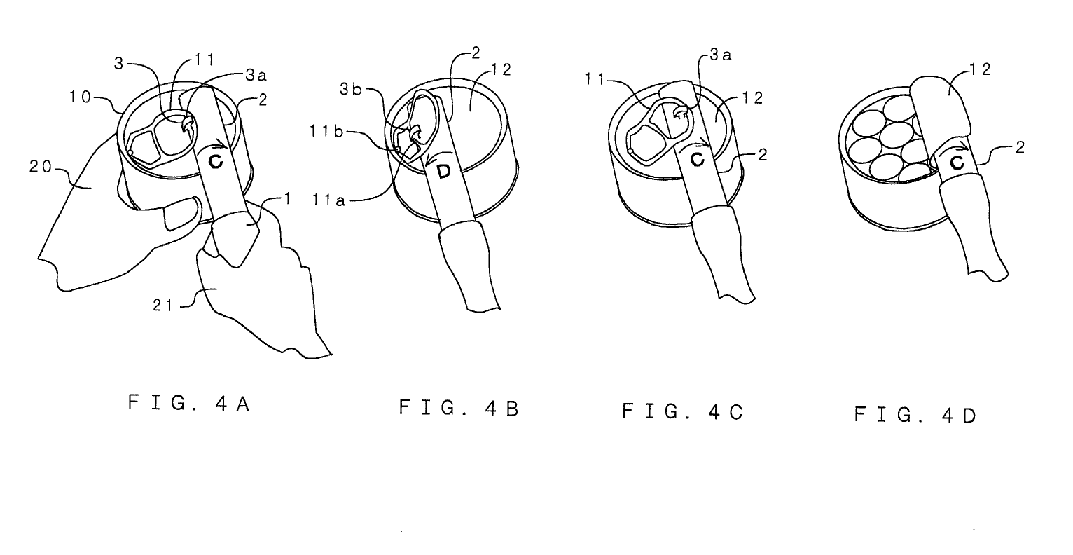

Although the can opener according to the present invention can open most pull-top cans in the manner described above, some pull-top cans cannot be opened since only the pull tab 11 shown in FIG. 3 is removed. In such a case, the pull-top cans are to be opened in the manner shown in FIG. 4.

At first, as illustrated in FIG. 4A, the can 10 is grasped by the left hand 20 and the can opener 1 is gripped by the right hand 21, and the pull tab 11 of the can 10 is caught by the claw 3a to rotate the main body 2 in a direction shown by the arrow C, which allows the overall engagement projection 3 to enter the opening of the pull tab 11.

Then, as illustrated in FIG. 4B, the main body 2 is rotated in a direction shown by the arrow D with the other claw 3b being engaged with an intermediate member 11a of the pull tab 11 to open a part of the cover 12.

Next, as illustrated in FIG. 4C, the pull tab 11 is caught by the claw 3a again and the main body 2 is rotated in a direction shown by the arrow C, which allows the cover 12 to gradually be opened.

Finally, as illustrated in FIG. 4D, the main body 2 is rotated further in a direction shown by the arrow C in such a manner that the cover 12 is rolled together with the main body 2, which allows the cover 12 to completely be removed.

Although two claws 3a, 3b are mounted to the circumferential surface 2a of the main body 2 in the above embodiment, one of the claws 3a, 3b is sufficient to open the pull-top can in the manner shown in FIG. 3. Since some pull-top cans cannot be opened in the manner shown in FIG. 3 and must be opened in the manner shown in FIG. 4, it is preferable to provide two claws 3a, 3b in advance. In addition, two claws 3a, 3b make the can opener 1 symmetrical about the axis thereof, which is useful for a left-handed person also.

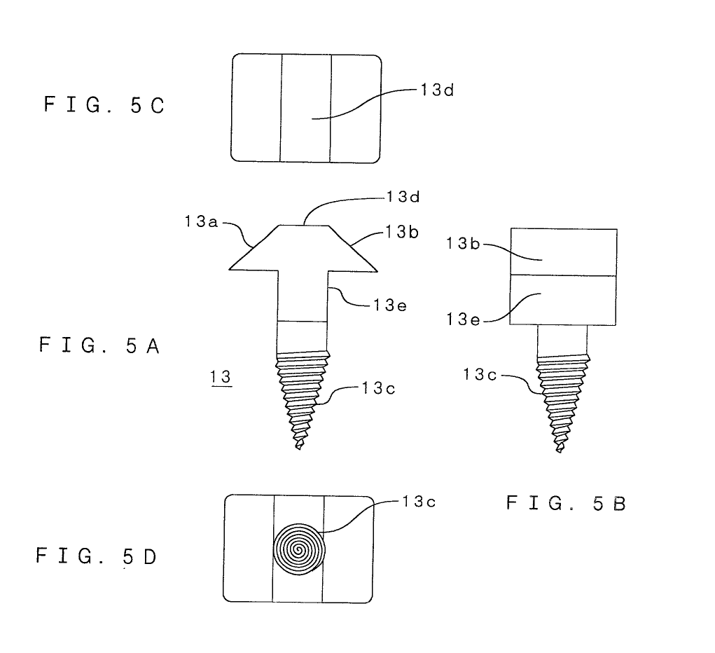

FIG. 5 shows another embodiment of the engagement projection 3 illustrated in FIG. 2. The engagement projection 13 shown in FIG. 5 also smoothly opens pull-top cans. Whether the engagement projection 3 in FIG. 2 or the engagement projection 13 in FIG. 5 should be used may be decided in accordance with the kinds of pull-top cans.

The engagement projection 13 shown in FIG. 5 is provided with two claws 13a, 13b at the upper portion thereof and a screwed portion 13c at the lower portion. A top portion 13d of the engagement projection 13 is formed to be rectangular when observed from upside. A trunk portion 13e between the claws 13a, 13b and the screwed portion 13c is formed to be a rectangular parallelepiped. Like the engagement projection 3 illustrated in FIG. 1, the engagement projection 13 is fixed to the circumferential surface 2a of the main body 2 through the screwed portion 13c in such a manner that the claws 13a, 13b are directed toward both directions parallel to the axis of the main body 2.

In the explanation on the above embodiment, the can opener according to the present invention is used to open pull-top cans. In addition, the can opener is applicable to open so-called stay-on cans used for refrigerated drink, coffee and the like. The stay-on can has a pull tab which stays on the cover of the can even after opened. In order to open the stay-on can, assuming that the pull tab 11 in FIG. 4 is a pull tab of a stay-on can, the motions shown in FIGS. 4A and 4B can open the can.

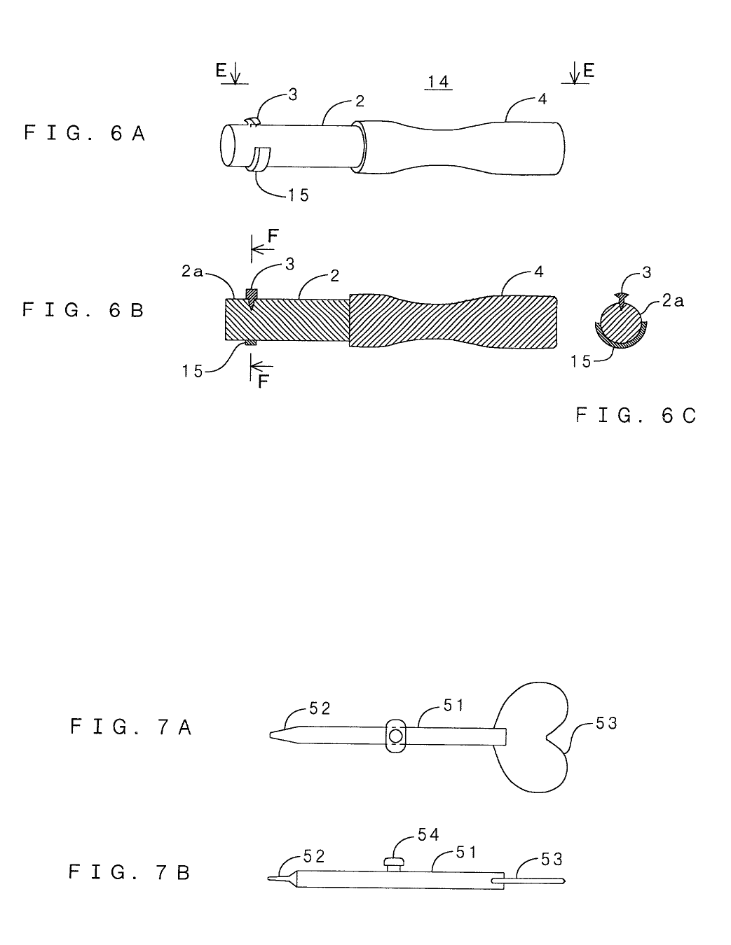

Next, a can opener according to another embodiment of the invention will be explained with reference to FIG. 6.

The can opener 14 is, in addition to the construction of the can opener 1 shown in FIG. 1, provided with a half-ring-shaped projection 15 on a face opposite the face of the circumferential surface 2a of the main body 2 where the engagement projection 3 stands. With this construction, when the claw 3b in FIG. 4B is engaged with the intermediate member 11a of the pull tab 11 and the main body 2 is rotated in the direction indicated by the arrow D, the projection 15 pushes a joint 11b of the pull tab 11, which causes the release of the engagement between the engagement projection 3 and the pull tab 11 to be more difficult, resulting in an easier opening operation. Further, the projection 15 allows the pull-top can to be opened through a portion that is slightly more outside than a portion of the outer circumferential surface of the main body 2 as a fulcrum, so that the pull-top can can be opened with smaller force.

In case that a stay-on can is opened with the can opener 14, it is possible to open the can with the motions shown in FIGS. 4A and 4B. It is also possible to insert the engagement projection 3 into the opening of the pull tab 11 from the opening side and engage the engagement projection 3 with the pull tab 11 to open the can.

As described above, with the can opener with simple construction according to the present invention, not only are pull-top cans and the like easily and safely opened, but also it is unnecessary to pay particular attention to the handling and storing of the can opener.

What is claimed is:

1. A can opener comprising:
a cylindrical main body defining an axis and a circumferential surface;
an engagement projection disposed on the circumferential surface of said main body, the engagement projection having a claw extending in a direction parallel to the axis of the main body; and
a handle for rotating the main body, the handle being continuous with the main body.

2. The can opener as claimed in claim 1, wherein the main body has an outer diameter in the range of from about 20 mm to about 25 mm.

3. The can opener as claimed in claim 1, further comprising a half-ring-shaped projection mounted to the circumferential surface of the main body in opposed relation to the engagement projection.

4. A can opener comprising:
a cylindrical main body defining an axis and a circumferential surface;
an engagement projection disposed on the circumferential surface of the main body, the engagement projection having two claws extending in parallel relation to the axis of the main body and in opposed relation to each other; and
a handle for rotating the main body, the handle being continuous with the main body.

5. The can opener as claimed in claim 4, wherein the main body has an outer diameter in the range of from about 20 mm to about 25 mm.

6. The can opener as claimed in claim 4, further comprising a half-ring-shaped projection mounted onto the circumferential surface of the main body in opposed relation to the engagement projection.
